(19) United States
(12) Patent Application Publication
(10) Pub. No.: US 2012/0330752 A1
(43) Pub. Date: Dec. 27, 2012

(54) SEARCH WORD LINK ADVERTISEMENT SYSTEM, METHOD FOR OPTIMIZING MATCHING PERIOD THEROF AND COMPUTER READABLE RECORDING MEDIUM THEREOF

(75) Inventor: Kyung Hoon KIM, Seongnam-si (KR)

(73) Assignee: NHN BUSINESS PLATFORM CORPORATION, Seongnam-si (KR)

(21) Appl. No.: 13/530,749

(22) Filed: Jun. 22, 2012

(30) Foreign Application Priority Data
Jun. 23, 2011 (KR) 10-2011-0061269

(51) Int. Cl. G06Q 30/02

(52) U.S. Cl. 705/14.54

(57) ABSTRACT

Disclosed herein is a search word link advertisement system including: an advertisement executing unit determining a search word link advertisement based on search words input during a matching period and exposing the determined search word link advertisement to provide the advertisement; a log recording unit storing a history of the determined search word link advertisement; and a matching period adjusting unit determining a transmission amount of search word link advertisement at any point in time or periodically in a state in which the search word link advertisement is provided and optimizing and adjusting the matching period according to the determined transmission amount.

### CROSS-REFERENCE TO RELATED APPLICATION

This application claims priority to and the benefit of Korean Patent Application No. 10-2011-0061269, filed on Jun. 23, 2011, which is hereby incorporated by reference for all purposes as if fully set forth herein.

### BACKGROUND

1. Field

Exemplary embodiments of the present invention relate to a search word link advertisement system, a method, and a computer readable recording medium for optimizing a matching period thereof, and more particularly, to a search word link advertisement system. The exemplary embodiments include determining a search word link advertisement based on search words input during a set basic matching period, exposing the determined search word link advertisement to execute the advertisement, judging a transmission amount of search word link advertisement at any point in time or periodically in a state in which the search word link advertisement is executed, and optimizing and adjusting the set basic matching period according to the judged transmission amount, a method for optimizing a matching period thereof, and a computer readable recording medium thereof.

2. Discussion of the Background

Users may obtain desired information by inputting a search word in a search engine. The information obtained by the users mainly reflects the users' interests. The users' interests become main information for an advertiser to accomplish an advertisement effect. A search word link advertisement service provides an advertisement service by exposing an advertisement linked to search words input by the users. In this case, a provided advertisement is called a search word link advertisement and may be linked by search words or criterion specified by the advertiser in advance.

In the case in which the user visits a specific site, when a search word link advertisement related to a content in which the user is interested in is provided, an advertisement effect may be maximized. Therefore, a method of selecting a content and an advertisement in which the user has an interest is required. Further, in order to recommend advertisement registration to an advertiser, a method of providing user's interest as an objective index is desired.

In this respect, when advertisements in which user's interest is reflected by associating identification information of the user, a search word related to the user, and an advertisement extracted through the search word with each other are provided, recency search time and an exposure frequency of the advertisement are reflected, such that an advertisement effect may be increased.

In addition, a process of reflecting a combination of the recency search time and the exposure frequency to determine a transmission priority of advertisements, thereby increasing the advertisement effect is desired.

When an accurate inventory for each search word in the search word link advertisement service may be predicted, the advertiser may predict an advertisement effect for a search word link advertisement that he/she purchases in advance.

However, in the case of the search link advertisement, there is the possibility that an expected exposure amount for each keyword will be significantly changed every week due to a real time suddenly rising search word, a seasonal factor, or the like. Therefore, it is actually difficult to accurately predict the inventory.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide a system and method for providing search word link advertisement by determining a search word link advertisement based on search words input during a predetermined matching period, exposing the determined search word link advertisement to execute the advertisement, and adjusting the matching period according to whether or not a transmission amount of search word link advertisement reaches a unit transmission target amount in a state in which the advertisement is executed to optimize the basic matching period, at the time of the search word link advertisement.

Additional features of the invention will be set forth in the description which follows, and in part will be apparent from the description, or may be learned by practice of the invention.

Exemplary embodiments of the present invention provide a system. The system includes an advertisement executing unit which is configured to determine a search word link advertisement based on search words input during a matching period and to expose the determined search word link advertisement to provide an advertisement. The system also includes a non-transitory log recording unit which is configured to store a history of the determined search word link advertisement. The system includes a matching period adjusting unit which is configured to determine a transmission amount of search word link advertisement at any point in time or periodically in a state in which the search word link advertisement is determined and to optimize and to adjust the set basic matching period according to the determined transmission amount.

Exemplary embodiments of the present invention also provide a method. The method includes determining a search word link advertisement based on search words input during a matching period and exposing the determined search word link advertisement to provide an advertisement. The method also includes storing a history of the determined search word link advertisement. And the method includes determining a transmission amount of search word link advertisement at any point in time or periodically in a state in which the search word link advertisement is provided and optimizing and adjusting the matching period according to the determined transmission amount.

Exemplary embodiments of the present invention also provide a non-transitory computer-readable recording medium comprising an executable program which, when executed, performs steps for optimizing a matching period of a search word link advertisement system. The steps includes determining a search word link advertisement based on search words input during a matching period and exposing the determined search word link advertisement to provide an advertisement. The steps includes storing a history of the determined search word link advertisement. And the steps includes determining a transmission amount of search word link advertisement at any point in time or periodically in a state in which the search word link advertisement is provided and optimizing and adjusting the set basic matching period according to the determined transmission amount.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a graph showing that a guarantee is not reached due to predicting that an inventory is higher as compared to an actual transmission amount in a search word link advertisement service according to exemplary embodiments of the present invention.

FIG. 2 is a graph showing that recency is not reached due to predicting that an inventory is lower as compared to an actual transmission amount in the search word link advertisement service according to exemplary embodiments of the present invention.

FIG. 3 is a diagram showing a search word link advertisement system according to exemplary embodiments of the present invention.

FIG. 4 is a flow chart of a process for describing a method for optimizing a matching period of the search word link advertisement system according to exemplary embodiments of the present invention.

FIG. 5 is a flow chart of a process describing a method for optimizing a matching period of the search word link advertisement system according to the exemplary embodiments of the present invention.

FIG. 6 is a diagram describing three different states according to whether or not a unit transmission target amount is reached.

FIG. 7 is a graph showing impressions (IMPs) and click through rates (CRTs) for each time generated at the time of a search word link advertisement performed in the search word link advertisement system according to the exemplary embodiments of the present invention.

FIG. 8 is a graph showing the case in which a matching period is set to recent seven days as an example of a decrease in matching period of the search word link advertisement system according to the exemplary embodiments of the present invention.

FIG. 9 is a graph showing the case in which a matching period is set to recent seven days*(search period 24 hour period±4 time) as an example of a decrease in matching period of the search word link advertisement system according to the exemplary embodiments of the present invention.

FIG. 10 is a graph showing the case in which a matching period is set to recent seven days*(search period 24 hour period±8 time) as an example of a decrease in matching period of the search word link advertisement system according to the exemplary embodiments of the present invention.

FIG. 11 illustrates an exemplary computing hardware (e.g., computer system) upon which exemplary embodiments according to the present invention can be implemented.

### DETAILED DESCRIPTION OF THE ILLUSTRATED EMBODIMENTS

Embodiments of the present invention will be described in detail with reference to the accompanying drawings. These embodiments will be described in detail for those skilled in the art in order to practice the present invention. It should be appreciated that various embodiments of the present invention are different but do not have to be exclusive. For example, specific shapes, configurations, and characteristics described in an embodiment of the present invention may be implemented in another embodiment without departing from the spirit and the scope of the present invention. In addition, it should be understood that position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, exemplary embodiments of the present invention will be described in detail with reference to the accompanying drawings so that those skilled in the art may easily implement the spirit of the present invention.

In the present specification, advertisement information, which is information configured of data such as a text, an image, a moving picture, audio, or the like, or a combination of at least two thereof, needs to be interpreted in the widest sense in which it includes information on advertiser's goods or services and a message that advertisers want to widely notice.

Further, in the present specification, advertisement goods generally indicate an advertisement publication right sold to the advertiser. One advertisement good may be linked to at least one advertisement information. In addition, the advertisement goods may be divided according to various criteria such as an area at which an advertisement is published, a rank in which the advertisement is published, and the like.

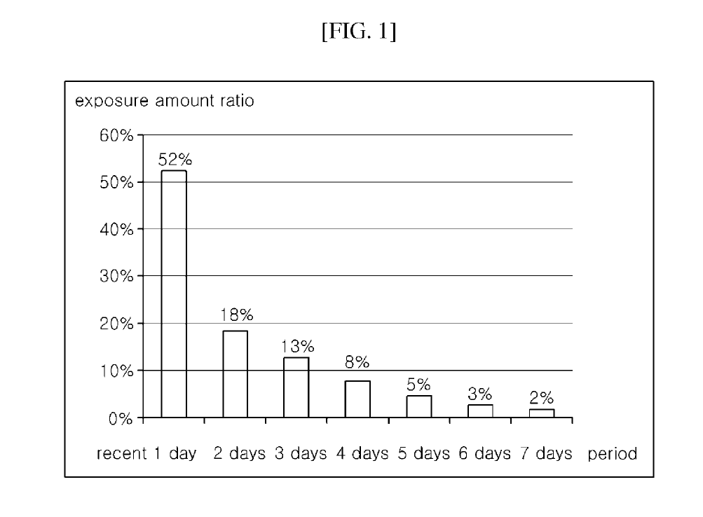

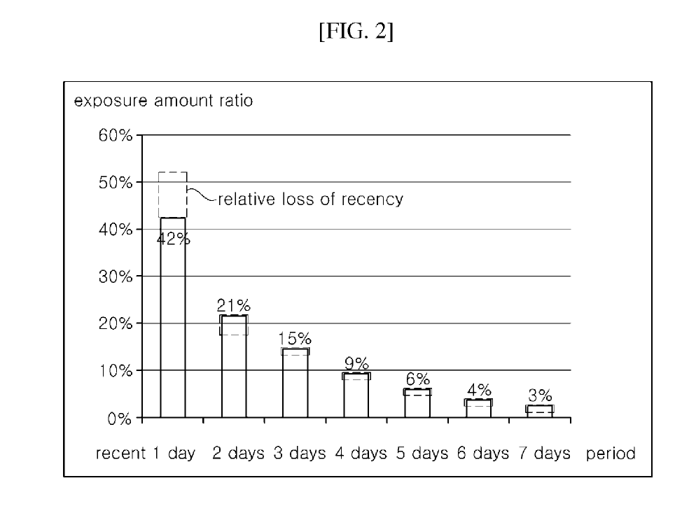

FIGS. 1 and 2 are graphs showing that the inventors discovered it is difficult to predict an inventory in a search word link advertisement service according to the related art according to exemplary embodiments of the present invention.

Referring to FIG. 1, at the time of predicting that an inventory is high, matching success rate of a recently input keyword is high, such that a click through rate (CTR) tends to be high; however, a case in which a target exposure amount is not reached may occur. That is, at the time of predicting that the inventory is higher as compared to an actual transmission amount, guarantee may not be reached.

Meanwhile, referring to FIG. 2, at the time of predicting that an inventory is low, since the entire transmission target amount may be consumed by other users, it is difficult for the advertiser to directly confirm exposure. Further, since a matching failure rate of the recently input keyword is high, the CTR tends to be low. That is, when comparing an exposure amount ratio for each period shown in FIG. 2 with an exposure amount ratio for each period shown in FIG. 1, it may be confirmed that guarantee may be reached; however, relative loss of the recency occurs.

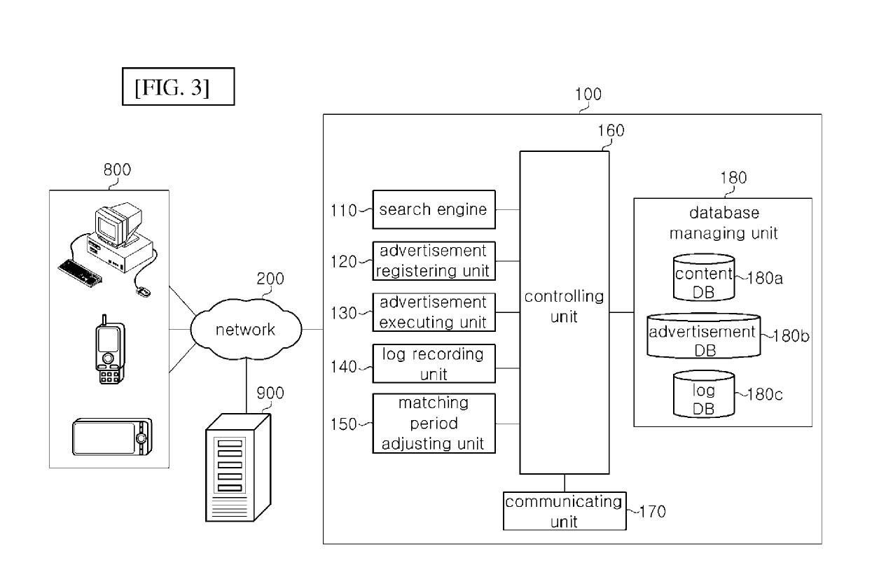

FIG. 3 is a diagram showing a schematic configuration of a search word link advertisement system 100 according to exemplary embodiments of the present invention.

The search word link advertisement system 100 according the exemplary embodiments of the present invention may communicate with a user terminal apparatus 800 and an advertiser system 900 through a communication network 200, register advertisement information for a search word link advertisement according to a request of the advertisement system 900, and provide the search word link advertisement according to information registered in the user terminal apparatus 800. Preferably, the advertisement system 100 may be included in an operation server of a search portal site providing various search word link advertisements.

Here, the communication network 200 may be configured regardless of a communication aspect such as wired communication and wireless communication, and may be various communication networks such as a local area network (LAN), a metropolitan area network (MAN), a wide area network (WAN), or the like. The communication network 100 described in the present invention may be the known World Wide Web (WWW).

According to the exemplary embodiment of the present invention, each of the user terminal apparatus 800 and the advertisement system 900 may be a digital device having a function of allowing a user that is to search/inquire goods, services, or information and an advertiser that is to provide search word link advertisements to the user to access the search word link advertisement system 100 through the communication network 200 and then perform communication or a system configured of the digital device. For example, the user terminal apparatus 800 and the advertisement system 900 according to exemplary embodiments of the present invention may be any digital device including a memory unit and a microprocessor mounted therein to have operational capability, such as a personal computer (for example, a desktop computer, a laptop computer, a tablet computer, a palmtop computer, or the like), a workstation, a personal digital assistant (PDA), a web pad, a mobile phone, or the like.

A detailed description will be provided with reference to FIG. 3. The search word link advertisement system 100 communicating with the user terminal apparatus 800 and the advertiser system 900 through the communication network 200 according to the exemplary embodiments of the present invention may be a server including a search engine 110, an advertisement registering unit 120, an advertisement executing unit 130, a log recording unit 140, a matching period adjusting unit 150, a controlling unit 160, a communicating unit 170, and a database managing unit 180.

According to the exemplary embodiments of the present invention, at least some of the search engine 110, the advertisement registering unit 120, the advertisement executing unit 130, the log recording unit 140, the matching period adjusting unit 150, the controlling unit 160, the communicating unit 170, and the database managing unit 180 may be included as an operation system, an application program module, and other program modules in the advertisement system 100 and be physically stored in several known storage apparatuses. In addition, these program modules may also be stored in a remote storage device capable of communicating with the advertisement system 100. Meanwhile, these program modules include, but are not limited to, a routine, a sub-routine, a program, an object, a component, a data structure, or the like, performing a specific task or executing a specific abstract data type to be described below according to the present invention.

In addition, according to the exemplary embodiments of the present invention, the search engine 110, the advertisement registering unit 120, the advertisement executing unit 130, the log recording unit 140, the matching period adjusting unit 150, the controlling unit 160, the communicating unit 170, and the database managing unit 180 may be present in a state in which they are distributed in a plurality of servers.

The search engine 110 according to the exemplary embodiments of the present invention may crawl a web document (in the present specification, the web document generally indicates data such as a text, an image, a moving picture, an audio, or the like, and digital data configured of a combination of at least two thereof) stored in various on-line remote computers (not shown) that may be accessed through the communication network 200 and store information on the crawled web document in a content database 180a to be described below. In addition, the search engine 110 according to the exemplary embodiments of the present invention may serve to provide a web document including at least one of digital data obtained from the content database 180a according to a request of the user terminal apparatus 800, search word link advertisement information obtained with reference to an advertisement database 180b, and a combination thereof to the user terminal apparatus 800.

The advertisement registering unit 120 according to the exemplary embodiments of the present invention may serve to store search word link advertisement information configured of data such as a text, an image, a moving picture, an audio, or the like, specified and/or selected by the advertiser according to the request of the advertiser system 900 and a combination of at least two thereof as advertisement data in an advertisement database 180b to be described below.

In addition, the advertisement registering unit 120 according to the exemplary embodiments of the present invention may provide an interface such as the known bidding tool in order to register the search word link advertisement information.

The advertisement executing unit 130 according to the exemplary embodiments of the present invention determines the search word link advertisement based on search words input during a set basic matching period and exposes the determined search word link advertisement to execute the advertisement. Here, the basic matching period means a period set so as to execute the advertisement by determining the search word link advertisement based on the search words input during any period and exposing the determined search word link advertisement.

The advertisement executing unit 130 may serve to receive a user input such as a search keyword, or the like, input to the search engine 110, search the search word link advertisement information matched to the user input from the advertisement database 180b, and insert at least a portion (for example, a uniform resource locator (URL) of a web page, a single line advertisement message, or the like) of the searched search word link advertisement information as the search word link advertisement into the web document to be provided to the user. Here, the advertisement executing unit 130 may also insert a program code allowing the user terminal apparatus 800 to be directly connected to the advertiser system 900 into the web document in the case in which the user performs an action, or the like, of selecting the search word link advertisement inserted into the web document.

The log recording unit 140 according the exemplary embodiments of the present invention may serve to store a record for a history of the search word link advertisement/the search word link advertisement information provided to the user terminal apparatus 800, a selection history of the user for the provided advertisement, using a mouse, a keyboard, or an input apparatus performing a function similar to the mouse or the keyboard, or the like, in a log database 180c to be described.

The matching period adjusting unit 150 according to the exemplary embodiments of the present invention may determine a transmission amount of search word link advertisement at any point in time or periodically in a state in which the search word link advertisement is executed and optimize and adjust the set basic matching period according to the judged transmission amount. For example, the matching period adjusting unit 150 may predict a vendible inventory with reference to the history for the search word link advertisement stored in the log database 180c to set the basic matching period, start transmitting the search word link advertisement in the set basic matching period to decrease the basic matching period when a unit transmission target amount is reached and increase the basic matching period when the unit transmission target amount is not reached, thereby optimizing and adjusting the basic matching period. That is, when an advertisement transmission amount (or an advertisement exposure amount) is equal to or higher than the unit transmission target amount, the period adjusting unit 150 decreases the matching period to decrease the number of linked search words, thereby decreasing the transmission amount of search word link advertisement. Meanwhile, when the advertisement transmission amount is lower than the unit target transmission amount, the period adjusting unit 150 increases the matching period to increase the number of linked search words, thereby increasing the transmission amount of search word link advertisement.

Meanwhile, the matching period adjusting unit 150 may provide the predicted inventory to the advertiser and receive at least one of a transmission period and a transmission amount of the search word link advertisement. Here, the matching period adjusting unit 150 may predict the vendible inventory based on the history for the search word link advertisement. According to the exemplary embodiments of the present invention, the matching period adjusting unit 150 may obtain the publication number of search word link advertisement, the selection number of search word link advertisement due to a mouse click action of the user, and the like, from the log database 180c when it predicts the vendible inventory or adjusting the basic matching period. In addition, the matching period adjusting unit 150 may judge whether or not the unit transmission target amount is reached to adjust the matching period according to whether or not the unit transmission target amount is reached.

According to the exemplary embodiments of the present invention, the matching period adjusting unit 150 may monitor the transmission amount of search word link advertisement to decrease the basic matching period when the unit transmission target amount is reached and increase the basic matching period when the unit transmission target amount is not reached, thereby optimizing and adjusting the basic matching period.

Here, whether or not the unit transmission target amount is reached may be judged by comparing the transmission amount of search word link advertisement with a reference transmission amount of search word link advertisement. The transmission amount of search word link advertisement according to the transmission of the search word link advertisement and the reference transmission amount of search word link advertisement may be based on impression (IMP) of the advertisement. The impression (IMP) of the published search word link advertisement indicates the number by which a search word link banner advertisement or a search word link keyword advertisement is displayed to visitors of any web site or the user of the user terminal apparatus 800. In the case in which the search word link advertisement is repeatedly viewed through refresh or reconnection after it is viewed, the impression (IMP) is accumulated. Therefore, in the case in which the matching period adjusting unit 150 adjusts the matching period with respect to the published search word link advertisement, the matching period adjusting unit 150 increases the basic matching period when the impression (IMP) of the published search word link advertisement is equal to or lower than the reference transmission amount and decreases the basic matching period from the moment at which the impression exceeds the reference transmission amount.

The controlling unit 160 according to the exemplary embodiments of the present invention serves to control a flow of data between the search engine 110, the advertisement registering unit 120, the advertisement executing unit 130, the log recording unit 140, the matching period adjusting unit 150, the communicating unit 170, and the database managing unit 180.

The communicating unit 170 serves to allow the search word link advertisement system 100 according to the exemplary embodiments of the present invention to communicate with external apparatuses such as the user terminal apparatus 800, the advertiser system 900, and the like.

The database managing unit 180 according to the exemplary embodiment of the present invention may include the content database 180a in which the information on the web document crawled by the search engine 110 is stored, the advertisement database 180b in which the information on the search word link advertisement registered by the advertiser is stored, the log database 180c in which the history of the search word link advertisement provided to the user terminal apparatus 800 and the publication or selection history of the search word link advertisement in the user terminal apparatus 800 are stored, and the like.

For example, the content database 180a may include web document identification information, a point in time at which the web document is collected, a title of the web document, abstract information of the web document, attribute information of the web document, and the like.

The database 180b may include advertisement identification information, advertiser identification information, information on an advertisement publication time, information on the basic matching period, information on the reference transmission amount, information on the adjustment of the matching period according to the advertisement selection, information on the search word link advertisement combined with the web document to be provided to the user terminal apparatus 800, and the like. Here, the predicted inventory means an advertisement transmission amount that may be basically provided to the advertiser during a preset advertisement publication period, and the reference transmission amount means an advertisement transmission amount expected during an advertisement publication period.

At least two types of data may be stored in the log database 180c. First, the history of the search word link advertisement information provided to the user terminal apparatus 800 may be stored in the log database 180c. Next, the history of the search word link advertisement information selected by the user terminal apparatus 800 may be stored in the log database 180c. The above-mentioned two types of data may be stored in physically separate databases or be logically distinguished from each other using a predefined identification flag. In the latter case, the log database 180c may include advertisement identification information, information on a point in time at which the advertisement is selected, an identification flag, and the like.

Although the database storing the information for implementing the present invention therein is classified into three databases, that is, the content database 180a, the advertisement database 180b, and the log database 180c in the above-mentioned embodiment, a configuration of the database including this classification may be changed by those skilled in the art as needed.

Finally, for example, the database includes a database in a broad sense in which it includes a computer file system based data record, or the like, as well as a database in a narrow sense. It should be appreciated that even a set of simple operational processing logs may be included in the database described in the present invention if it may be searched to extract a predetermined data.

As described above, the matching period adjusting unit 150 may start transmission in the predetermined basic matching period and judge whether or not the unit transmission target amount is reached, thereby determining an increase/decrease in the basic matching period according to whether or not the unit transmission target amount is reached. Whether or not the unit transmission target amount may be determined by referencing the publication history of the advertisement during the reference period.

According to the exemplary embodiments of the present invention, the basic matching period may be determined based on a minimum transmission amount value calculated for each advertisement good during a predetermined period.

According to the exemplary embodiments of the present invention, the publication number of advertisement according to each advertisement good during any past period (hereinafter, referred to as a “reference period”) (for example, during past one month) may be set to the reference transmission amount of the corresponding advertisement.

According to the exemplary embodiments of the present invention, each advertisement good may be linked to an advertisement publication condition such a search keyword, or the like. In this case, the reference transmission amount may be determined with reference to search word link publication histories for each search keyword during the reference period. For example, the reference transmission amount, which corresponds to aggregation of the number of queries (hereinafter, referred to as a “query count”) may be replaced by aggregation of the publication number of corresponding advertisement. Meanwhile, in the case in which the number of search word link advertisement goods linked to the search keyword is more than that of search word link advertisements provided as a search result of a corresponding search keyword, the query count value may be appropriately changed or the number of advertisements actually published and displayed on an advertisement list may be aggregated and used.

Meanwhile, the case in which the search word link advertisement is published in link with the search keyword has been described in the above-mentioned exemplary embodiments. However, in the case in which the search word link advertisement is linked to a web document, the reference transmission amount of search word link advertisement may be determined with reference to the web document during the reference period. For example, the reference transmission amount may also be determined based on the inquiry number of web document including the search word link advertisement without an input of the search keyword by the user. For example, in the case of a banner advertisement published on a main page of a search portal site, the reference transmission amount may be determined based on a number of displays of main page on the user terminal apparatus 800 by the user.

According to the exemplary embodiments of the present invention, the basic matching period for the advertisement goods may be set according to the reference transmission amount of the search word link advertisement described above.

According to the exemplary embodiments of the present invention, the basic matching period of the advertisement goods may be set in proportion to whether or not the unit transmission target amount is reached. Particularly, in the case in which costs (that is, advertisement costs generated when the advertisement is exposed once) according to the advertisement exposure are different for each advertisement good, the basic matching period may be set in consideration of the reference transmission amount and the advertisement exposure cost. In addition, the basic matching period may be adjusted according to factors such as a rank in which the advertisement is published, a preference of the advertiser, and the like.

The matching period for the search word link advertisement is decreased by decreasing the basic matching period step by step at the moment at which the transmission amount according to the impression for the published search word link advertisement exceeds to the reference transmission amount.

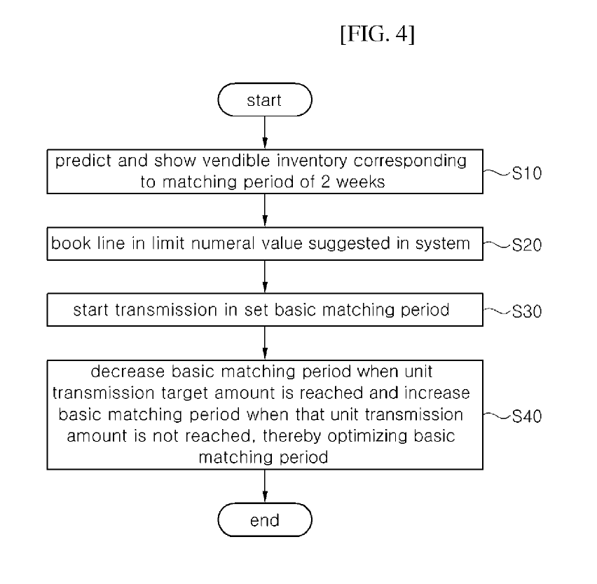

FIG. 4 is a flow chart of a process for describing a method for optimizing a matching period of the search word link advertisement system according to the exemplary embodiments of the present invention.

Referring to FIG. 4, in step (S10), the matching period adjusting unit 150 predicts a vendible inventory corresponding to a matching period of 2 weeks and stores the predicted vendible inventory as advertisement data in the advertisement database 180b. Therefore, the advertisement registering unit 120 provides an interface such as the known bidding tool to the advertiser system 900 in order to register the search word link advertisement information, thereby allowing the advertiser to view the predicted vendible inventory. Therefore, the advertiser registers a desired search word link advertisement through the advertisement registering unit 120.

In step (S20), the advertisement executing unit 130 books a line for a search word link advertisement service in a limit numeral value stored in the advertisement database 180b.

In step (S30), the matching period adjusting unit 150 starts transmitting the search word link advertisement in the basic matching period set in the advertisement database 180b. In step (S40), the matching period adjusting unit 150 monitors a real time advertisement transmission amount according to the search word link advertisement to periodically judge whether the unit transmission target amount is reached. The matching period is decreased when it is judged that the unit transmission target amount is reached and is increased when it is judged that the unit transmission amount is not reached, thereby optimizing the matching period. Here, a period at which it is judged whether the unit transmission target amount is reached may be variously selected among, for example, 5 minutes, 1 hour, 12 hours, and 1 day. In addition, an increase/decrease unit in matching period may be variously determined. The increase/decrease unit in matching period may be selected among, for example, 6 hours, 12 hours, 1 day, 2 days, 3 days, 5 days, 7 days, 10 days, and 14 days.

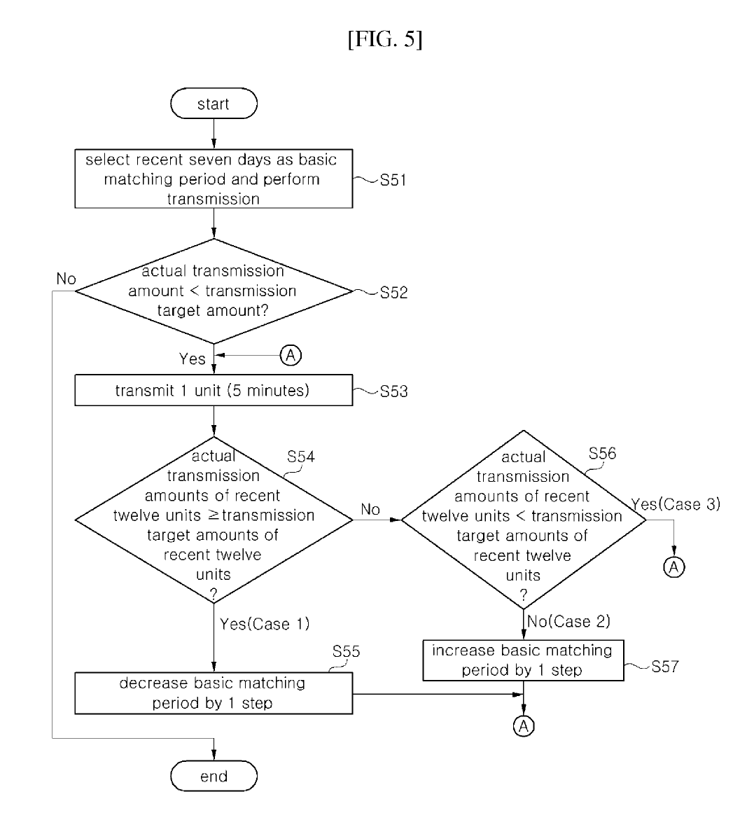

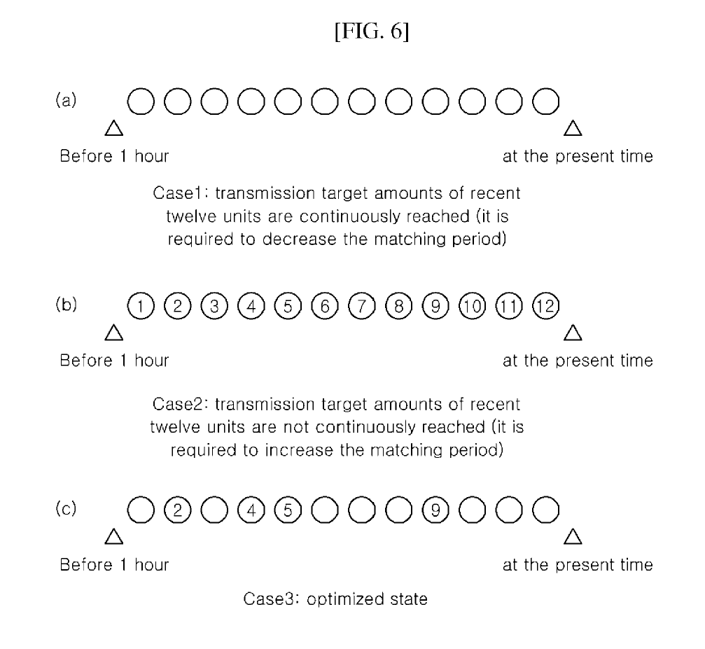

FIG. 5 is a flow chart of a process for describing a method for optimizing a matching period of the search word link advertisement system according to the exemplary embodiments of the present invention in detail; and FIG. 6 is a diagram describing three different states according to whether or not a unit transmission target amount is reached.

Referring to FIG. 5, in step (S51), the matching period adjusting unit 150 selects recent seven days as the basic matching period and performs transmission for a search word link advertisement.

In step (S52), the matching period adjusting unit 150 judges whether an actual transmission amount is smaller than a transmission target amount. In the case in which it is judged that the actual transmission amount is smaller than the transmission target amount, the matching period adjusting unit 150 transmits one unit every five minute in step (S53). In step (S54), the matching period adjusting unit 150 judges that actual transmission amounts of recent twelve units are continuously equal to or larger than transmission target amounts of recent twelve units. In the case in which it is judged that the actual transmission amounts of recent twelve units are continuously equal to or larger than the transmission target amounts of recent twelve units, the matching period adjusting unit 150 decreases the matching period by one step in step (S55). This case may be classified into a Case1 state of FIG. 6. The Case1 state is a state in which the transmission target amounts of recent twelve units are continuously reached. Therefore, in the Case1 state, it is required to decrease the matching period.

Meanwhile, in the case in which it is judged in step (S54) that the actual transmission amounts of recent twelve units are not continuously equal to or larger than the transmission target amounts of recent twelve units, the matching period adjusting unit 150 judges whether the actual transmission amounts of recent twelve units are continuously smaller than the transmission target amounts of recent twelve units, in step (S56). In the case in which it is judged that the actual transmission amounts of recent twelve units are continuously smaller than the transmission target amounts of recent twelve units, the matching period adjusting unit 150 increases the matching period by one step in step (S57). This case may be classified into a Case2 state of FIG. 6. The Case2 state is a state in which the transmission target amounts of recent twelve units are continuously not reached. Therefore, in the Case2 state, it is required to increase the matching period.

Meanwhile, the case in which it is judged in step (S56) that the actual transmission amounts of recent twelve units are not continuously smaller than the transmission target amounts of recent twelve units may be classified into a Case3 state of FIG. 6. The Case3 state is an optimized state. Therefore, in the Case3 state, a previously set matching period is maintained as it is.

Meanwhile, an increase/decrease unit in basic matching period may be variously determined. For example, the increase/decrease unit in basic matching period may be selected among recent 1 hour, recent 3 hours, recent 6 hours, recent 12 hours, recent 1 day, recent 2 days, recent 3 days, recent 5 days, recent 7 day, recent 10 days, and recent 14 days as a simple increase form.

Meanwhile, the increase/decrease unit in basic matching period may be set to, for example, a 24 hour period consideration form. That is, the increase/decrease unit in basic matching period may be selected among recent 1 hour, recent 3 hours, recent 6 hours, recent 12 hours, recent 1 day, recent 1 day+2 days*Prime (meaning a time zone in which an advertisement is maximally exposed) 4 h, recent 2 days, recent 2 days+3 days*Prime 4 h, recent 3 days, recent 3 days+(3 to 5) days*Prime 4 h, recent 5 days, recent 5 days+(5 to 7) days*Prime 4 h, recent 7 days, recent 7 days+(8 to 14) days*Prime 4 h, recent 7 days+(8 to 14) days*Prime 8 h, recent 7 days+(8 to 14) day*Prime 12 h, and recent 7 days+(8 to 14) days entirety.

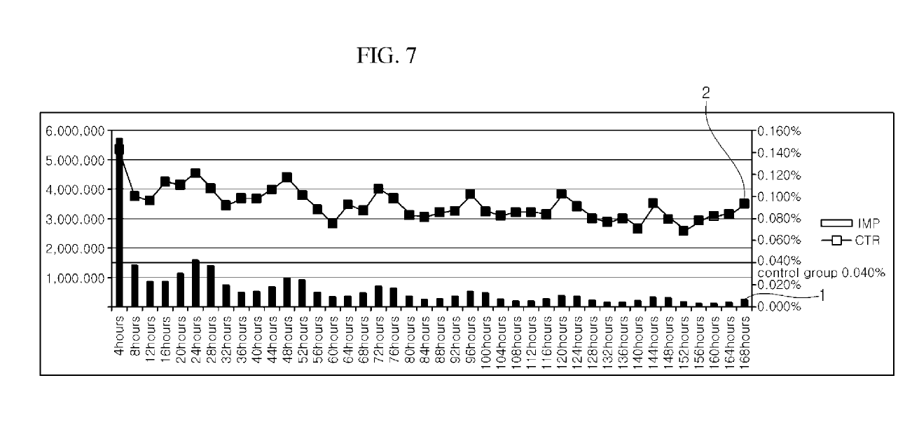

FIGS. 7 to 10 are graphs describing the case in which a 24 hour period consideration form is applied as an increase/decrease unit in matching period in the search word link advertisement system according to the exemplary embodiment of the present invention.

FIG. 7 is a graph showing IMPs and CTRs for each time generated at the time of a search word link advertisement performed in the search word link advertisement system according to the exemplary embodiment of the present invention.

Referring to FIG. 7, IMPs 1 and CTRs 2 for each time generated from a search point in time to recent 4 hours to recent 168 hours may be shown. The 24 hour period consideration form has been perceived from the fact that a CTR peak is generated every 24 hour after the search point in time as seed in FIG. 7.

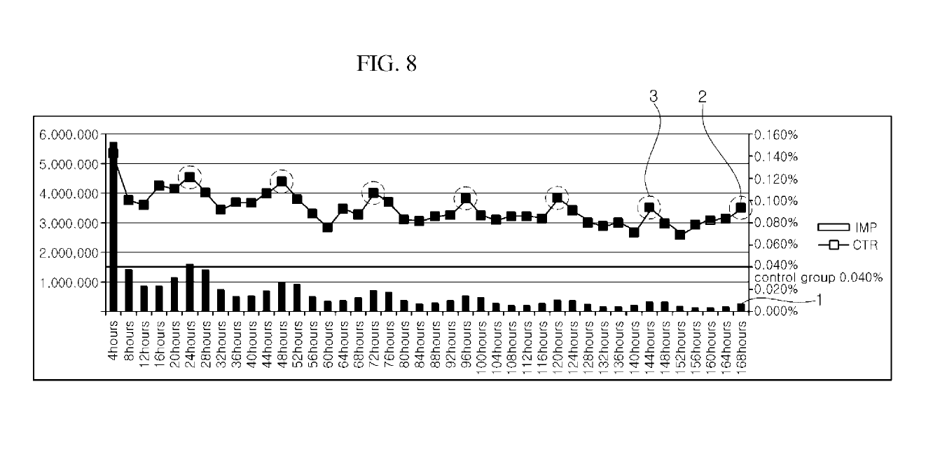

FIG. 8 is a graph showing the case in which a matching period is set to recent seven days as an example of a decrease in matching period of the search word link advertisement system according to the exemplary embodiments of the present invention. Therefore, a CTR peak 3 every 24 hour is excluded from the matching period.

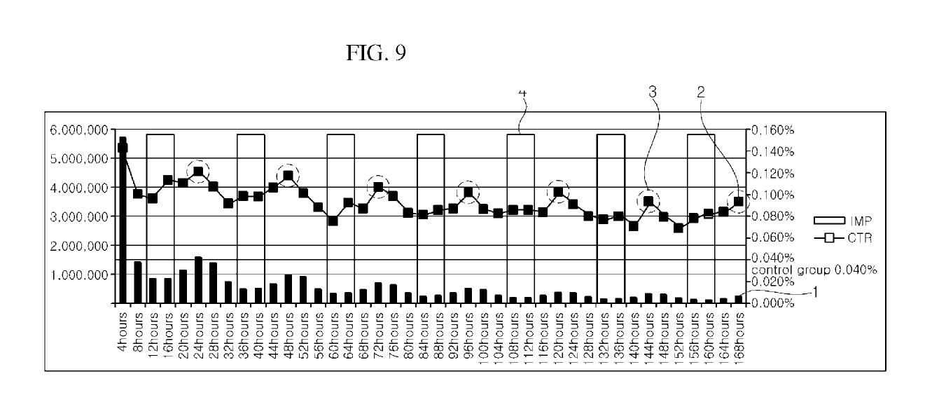

FIG. 9 is a graph showing the case in which a basic matching period is set to recent seven days*(search period 24 hour period±4 time) as an example of a decrease in basic matching period of the search word link advertisement system according to the exemplary embodiments of the present invention. Therefore, a period 4 corresponding to search period 24 hour period±4 time as well as the CTR peak 3 every 24 hour is excluded from the basic matching period.

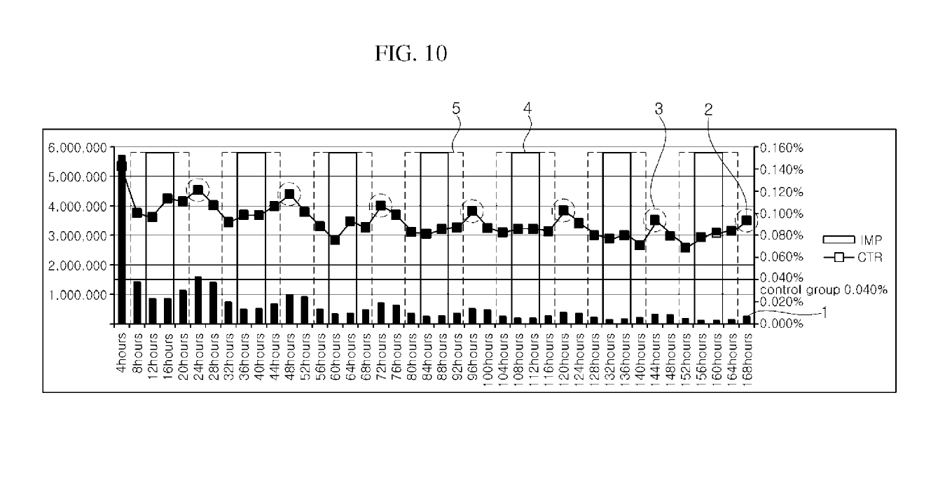

FIG. 10 is a graph showing the case in which a basic matching period is set to recent seven days*(search period 24 hour period±8 time) as an example of a decrease in basic matching period of the search word link advertisement system according to the exemplary embodiments of the present invention. Therefore, a period 5 corresponding to search period 24 hour period±8 time as well as the CTR peak 3 every 24 hour is excluded from the basic matching period and the period 4 corresponding to search period 24 hour period±4 time is excluded from the basic matching period.

To the contrary, in the case of increasing the basic matching period, the basic matching period may be set to recent 7 days+(8 to 14) days*(search time 24 hour period±4 time), recent 7 days+(8 to 14) days*(search time 24 hour period±8 time), and recent 7 days+(8 to 14) days*the entirety(the entirety of 2 weeks) through an opposite process to the above-mentioned process.

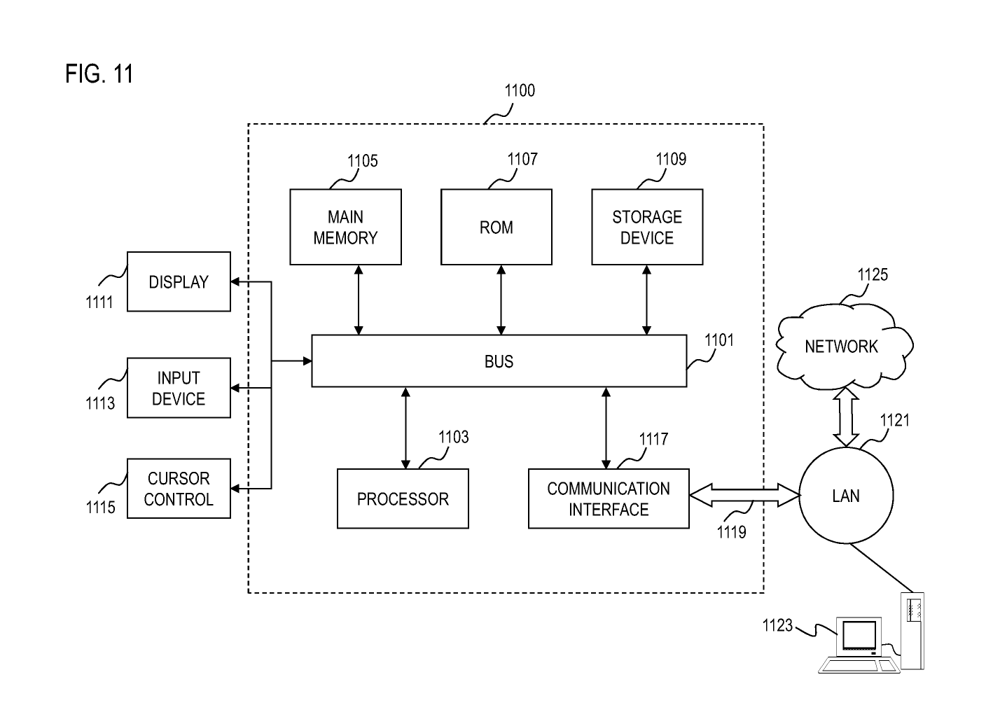

FIG. 11 illustrates computing hardware (e.g., computer system) 1100 upon which an embodiment according to the invention can be implemented. The computer system 1100 includes a bus 1101 or other communication mechanism for communicating information and a processor 1103 coupled to the bus 1101 for processing information. The computer system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions by the processor 1103. The computer system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to an embodiment of the invention, the processes described herein are performed by the computer system 1100, in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. Thus, embodiments of the invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the invention through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

Hereinabove, although the present invention is described by specific matters such as concrete components, and the like, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the sprit of the present invention should not be limited to the above-described exemplary embodiments, and the following claims as well as all modified equally or equivalently to the claims are intended to fall within the scope and spirit of the invention.

What is claimed is:

1. A search word link advertisement system comprising:
an advertisement executing unit configured to determine a search word link advertisement based on search words input during a matching period and to expose the determined search word link advertisement to provide an advertisement;
a non-transitory log recording unit configured to store a history of the determined search word link advertisement; and
a matching period adjusting unit configured to determine a transmission amount of search word link advertisement at any point in time or periodically in a state in which the search word link advertisement is determined and to optimize and adjust the matching period according to the determined transmission amount.

2. The search word link advertisement system of claim 1, wherein the matching period adjusting unit is configured to provide a predicted inventory to an advertiser and to receive at least one of a transmission period and a transmission amount of the search word link advertisement from the advertiser.

3. The search word link advertisement system of claim 2, wherein the matching period adjusting unit is configured to predict a vendible inventory based on the history of the search word link advertisement.

4. The search word link advertisement system of claim 1, wherein the matching period adjusting unit is configured to decrease the basic matching period when a transmission amount of search word link advertisement reaches a unit transmission target amount and to increase the basic matching period when it does not reach the unit transmission target amount, thereby to optimize the basic matching period.

5. The search word link advertisement system of claim 4, wherein the unit transmission target amount is determined with reference to a publication history of the search word link advertisement during a reference period stored by the log recording unit.

6. The search word link advertisement system of claim 5, wherein the search word link advertisement is linked to search keywords, and the unit transmission target amount is determined with reference to an advertisement publication history for each of the search keywords during the reference period.

7. The search word link advertisement system of claim 6, wherein the unit transmission target amount is determined by search number of each search keyword during the reference period.

8. The search word link advertisement system of claim 4, wherein the search word link advertisement is linked to a web document, and the unit transmission target amount is determined with reference to the web document during a reference period.

9. A method using a processor for optimizing a matching period of a search word link advertisement, comprising:
determining a search word link advertisement based on search words input during a matching period and exposing the determined search word link advertisement to provide an advertisement;
storing a history of the determined search word link advertisement; and
determining, by the processor, a transmission amount of search word link advertisement at any point in time or periodically in a state in which the search word link advertisement is provided and optimizing and adjusting the matching period according to the determined transmission amount.

10. The method of claim 9, wherein in the adjusting of the matching period, a predicted inventory is provided to an advertiser and at least one of a transmission period and a transmission amount of search word link advertisement is received from the advertiser.

11. The method of claim 10, wherein in the adjusting of the matching period, a vendible inventory is predicted based on the history of the search word link advertisement.

12. The method of claim 9, wherein in the adjusting of the matching period, the basic matching period is decreased when a transmission amount of search word link advertisement reaches a unit transmission target amount and the basic matching period is increased when it does not reach the unit transmission target amount, thereby optimizing the basic matching period.

13. The method of claim 12, wherein the unit transmission target amount is determined with reference to a publication history of the search word link advertisement during a reference period stored in the storing of the history.

14. The method of claim 13, wherein the search word link advertisement is linked to search keywords, and the unit transmission target amount is determined with reference to an advertisement publication history for each of the search keywords during the reference period.

15. The method of claim 14, wherein the unit transmission target amount is determined by the search number of the search keyword during the reference period.

16. The method of claim 9, wherein the search word link advertisement is linked to a web document, and the unit transmission target amount is determined with reference to the web document during a reference period.

17. A non-transitory computer-readable recording medium comprising an executable program which, when executed, performs steps for optimizing a matching period of a search word link advertisement, comprising:
determining a search word link advertisement based on search words input during a matching period and exposing the determined search word link advertisement to provide an advertisement;
storing a history of the determined search word link advertisement; and
determining a transmission amount of search word link advertisement at any point in time or periodically in a state in which the search word link advertisement is provided and optimizing and adjusting the matching period according to the determined transmission amount.
